(19) United States
(12) Patent Application Publication
(10) Pub. No.: US 2023/0405551 A1
(43) Pub. Date: Dec. 21, 2023

(54) PROCESS FOR PREPARATION OF CHROMATOGRAPHY MEMBRANES

(71) Applicant: DDP SPECIALTY ELECTRONIC MATERIALS US, LLC, Wilmington, DE (US)

(72) Inventors: Jayesh Dharia, Landenberg, PA (US); Michael Ostrander, Ambler, PA (US)

(73) Assignee: DDP SPECIALTY ELECTRONIC MATERIALS US, LLC, Wilmington, DE (US)

(21) Appl. No.: 18/198,349

(22) Filed: May 17, 2023

Related U.S. Application Data
(60) Provisional application No. 63/342,907, filed on May 17, 2022.

(51) Int. Cl. B01J 20/26; B01J 20/28; B01J 20/289; B01J 20/32; B01D 15/38

(52) U.S. Cl. CPC B01J 20/265; B01J 20/28052; B01J 20/28035; B01J 20/28038; B01J 20/289; B01J 2220/54; B01J 20/3278; B01J 20/3297; B01J 20/321; B01D 15/3828; B01J 20/3219

(57) ABSTRACT

A method for producing a chromatography medium by:
a) exposing a nanoweb sheet having mean flow pore size from 0.1 to 5 μm and a porosity from 40 to 90 volume % to a gaseous phase comprising a vinyl monomer to produce a functionalized nanoweb sheet;
b) layering a plurality of functionalized nanoweb sheets to form a functionalized nanoweb stack;
c) cutting the functionalized nanoweb stack with a die to form die-cut functionalized nanoweb stacks having regular shapes; and
d) exposing the die-cut functionalized nanoweb stacks in an aqueous medium to a ligand such as a protein which is capable of forming covalent bonds.

### CROSS-REFERENCE TO RELATED APPLICATIONS

The present application claims priority under 35 U.S.C. § 119 to U.S. Provisional Appln. No. 63/342,907, filed on May 17, 2022, which is incorporated herein by reference in its entirety.

### FIELD OF THE INVENTION

This invention relates generally to a method for producing a functionalized nanoweb useful in chromatography. In particular, a method for producing die-cut functionalized nanoweb stacks having regular shapes is provided.

### BACKGROUND OF THE INVENTION

Several patents, patent applications and publications are cited in this description in order to more fully describe the state of the art to which this invention pertains. The entire disclosure of each of these patents, patent applications and publications is incorporated by reference herein.

During the production of biopharmaceuticals, in particular antibody derived therapeutics, e.g., monoclonal antibodies, an affinity capture and elute purification step is frequently employed. This step most typically involves the binding of the desired therapeutic by a protein ligand conjugated to a chromatography support. Some support materials require surface functionalization prior to attachment of the protein ligand to the functionalized support surface.

Fibers have been used as support materials, e.g., in Z. Ma et al., Chromatogr. B, 877 (2009) 3686-3694, fibers are exposed to an air plasma then immersed in a liquid-phase of methacrylic acid to react and produce a functionalized fiber. In a separate step, in a liquid-phase reaction, a protein is bound to the functionalized fiber via amino groups on the protein to form the chromatography support. Typically, sheets of the functionalized fiber are stacked and fused under pressure and heat, then cut to the desired size to fit into a chromatographic device (see, e.g., WO 2015/052460). This is a multistep process which requires stacking several sheets of functionalized fiber first and then performing wet chemistry to functionalize with a protein ligand. Functionalized membrane is then cut into the required size using a suitable die. Even though samples are stacked together, there is always a waste of final product because there always be unusable area after required size of the membrane is cut from the stacked membrane sheet.

### SUMMARY OF THE INVENTION

Provided herein is a method for producing a chromatography medium, said method comprising steps of: a) exposing a nanoweb having mean flow pore size from 0.1 to 5 μm and a porosity from 40 to 90 volume % to a gaseous phase comprising a vinyl monomer to produce a functionalized nanoweb; b) layering a plurality of sheets of functionalized nanoweb to form a functionalized nanoweb stack; c) cutting said functionalized nanoweb stack with a die to form die-cut functionalized nanoweb stacks having regular shapes; and d) exposing said die-cut functionalized nanoweb stacks in an aqueous medium to a protein or ligand which is: (i) capable of binding another protein to an active site, and (ii) optionally comprises a free thiol or amino group.

The present invention is further directed to a method for producing a chromatography medium from sheets of functionalized nanoweb having mean flow pore size from 0.1 to 5 μm, a porosity from 40 to 90 volume %, and functional groups reactive with thiol or amino groups; said method comprising steps of: a) layering a plurality of sheets of functionalized nanoweb to form a functionalized nanoweb stack; b) cutting said functionalized nanoweb stack with a die to form die-cut functionalized nanoweb stacks having regular shapes; and c) exposing, said die-cut functionalized nanoweb stacks in an aqueous medium to a protein or ligand which is: (i) capable of binding another protein to an active site, and (ii) comprises a free thiol or amino group.

### DETAILED DESCRIPTION

All percentages are weight percentages (wt %), and all temperatures are in ° C. unless otherwise indicated. Averages are arithmetic averages unless indicated otherwise. All operations are performed at room temperature (from 10 to 40° C., preferably from 18 to 25° C.) unless specified otherwise. The terms “(meth)acrylate”, “(meth)acrylic”, and “(meth)acrylamide” mean acrylate or methacrylate, acrylic or methacrylic, and acrylamide or methacrylamide, respectively (collectively “acrylic monomers”). An acrylic polymer is a polymer comprising at least 50 wt % polymerized units of (meth)acrylic acid, alkyl, glycidyl or hydroxyalkyl (meth)acrylates, alkyl, glycidyl and/or hydroxyalkyl (meth)acrylamides, or a combination thereof. A carbohydrate polymer is a polymer comprising polymerized units of sugar molecules, i.e., a polysaccharide; polysaccharides functionalized via ether or ester groups are considered to be within this definition.

Preferably, from 2 to 25 sheets of functionalized nanoweb are layered to form a functionalized nanoweb stack, preferably at least 3 sheets, preferably at least 4 sheets; preferably no more than 20 sheets, preferably no more than 15 sheets. Preferably, each sheet has an area from 300 to 3,000 cm², preferably at least 600 cm², preferably at least 800 cm²; preferably no more than 2,500 cm², preferably no more than 2,000 cm², preferably no more than 1,800 cm². Preferably, no adhesive is applied between the sheets of functionalized nanoweb. Preferably, the thickness of each sheet of functionalized nanoweb is from 5 to 30 microns; preferably at least 7 microns, preferably at least 8 microns, preferably at least 9 microns: preferably no more than 25 microns, preferably no more than 20 microns. Preferably, the functionalized nanoweb stack is immobilized on a support, preferably by adhering its edges to the support, e.g., with adhesive or adhesive tape. Preferably, the adhesive or tape does not extend more than 20 mm over the functionalized nanoweb, preferably not more than 10 mm. Preferably, the stack is cut with a die into regular geometric shapes, e.g., circles, rectangles, squares, triangles, pentagons, hexagons, octagons, or ellipses; preferably round shapes, including circles, and rectangles, including squares. Preferably, the longest dimension of the cut shapes (diameter for a circle, longest side for triangle, longest diagonal for polygons, major axis for an ellipse) is from 10 to 200 mm, preferably from 15 to 100 mm, preferably from 20 to 80 mm. Preferably, the functionalized nanoweb stack is not under pressure at any point except along the cutting surface of the die. The pressure on the die required to cut through the stack may be determined for any equipment used for this purpose. Any higher pressure would not affect the results of this process. The time in contact with the die is at least the time necessary to cut completely through the stack; longer times will not affect results. Preferably the functionalized nanoweb stack and the die are at room temperature. Preferably the functionalized nanoweb sheets in the die-cut functionalized nanoweb stack are adhered only at their edges, preferably by means of the die-cutting.

A web of randomly distributed fibers is commonly referred to as a “nonwoven.” The fibers can be bonded to each other or unbonded, preferably unbonded. A “nanoweb” is a nonwoven web comprising at least one nanofiber. A nanoweb may also be referred to as a “nanofiber mat.” Preferably, the fibers in the nanoweb are “continuous,” i.e., having been laid down in one continuous stream to form the web. Fiber diameters may be determined by SEM picture examination. Preferably the fiber has a diameter from 0.1 to 1 μm. Preferably, at least 95% of the fiber has a diameter in the stated range, based on length of the fiber. Preferably, if less than 95% of the fiber has a diameter in the stated range, then fiber diameter is the arithmetic average of at least 50 measurements, preferably at least 100 measurements.

Preferably, the nanoweb has a mean flow pore size of at least 0.15 μm, preferably at least 0.2 μm, preferably at least 0.25 μm; preferably no more than 2 μm, preferably no more than 1 μm, preferably no more than 0.5 μm. Mean flow pore size is a calculated quantity from material porosimetry measurements, where the dry sample is subjected to airflow at various flow rates, then wetted with a fluid of known surface tension and air flows are returned at steadily increasing flow rate until the last wetted pore of the material is evacuated with air. A mean flow pore is determined from a ½ slope of the dry air flow curve intersecting the wet flow curve.

Relationships between fiber diameter and mean flow pore size have been determined. Simmonds et al proposed the following relationship to determine mean flow pore size, D_{mean,pore} from the mean fiber diameter of the nonwoven, D_{fiber} (see Simmonds G E, Bomberger J D, Bryner M A. Designing nonwovens to meet pore size specifications. J Eng Fibers Fabrics. 2007;2(1),1-15.)

D_{mean,pore}=0.39267*D_{fiber}/(1-porosity)

Preferably, the nanoweb has a porosity from 40 to 90 volume %, preferably at least 50 volume %, preferably at least 60 volume %; preferably no more than 85 volume %, preferably no more than 80 volume %, preferably no more than 75 volume %. It is believed that fluid flow through the nanofiber mat is facilitated by high porosity, and binding capacity of a substrate is improved when the pore size is small. Preferably when pore size is 0.1 to 1 micron, porosity is 50 to 90 volume %; preferably when pore size is 0.1 to 0.5 micron, porosity is from 65 to 85 volume % Porosity is calculated from the following equation:

Porosity=1−(mass of fiber in g/cm²/(Thickness of nanofiber mat in cm*Polymer Density in g/cm³))

Preferably, the fiber comprises a synthetic polymer; preferably poly(vinylidene fluoride) (PVDF), copolymers of PVDF such as poly(vinylidene fluoride-co-trifluoroethylene), polyamide, polyethersulfone (PES), polyethylene, polypropylene, polyester, polyimide or a combination thereof; preferably the fiber comprises PVDF, polyethersulfone, nylon or a combination thereof. Preferably, a PVDF polymer has a number average molecular weight is from 100,000 to 2,000,000 daltons, preferably from 200,000 to 500.000. Preferably, a polyamide has a number average molecular weight from 5,000 to 40,000, preferably from 10,000 to 20,000. Preferably, a polyethersulfone has a number average molecular weight from 20,000 to preferably from 40,000 to 60,000. In a preferred embodiment of the invention the fiber comprises PVDF; preferably the fiber comprises at least 50 wt % PVDF, preferably at least 80 wt %, preferably at least 90 wt %, preferably at least 95 wt %.

Preferably, the functionalized nanoweb comprises functional groups that are reactive with thiol or amino groups, preferably functional groups reactive with thiol groups. Preferably the functional groups are epoxy groups, maleimide groups, maleic anhydride groups, 2-pyridyl groups, vinyl sulphone groups or acetylene groups; preferably epoxy, maleic anhydride or maleimide groups; preferably epoxy groups. Preferably, the functional groups are reactive with thiol or amino groups, preferably thiol groups, at room temperature.

Preferably, the vinyl monomer comprises at least one epoxy group; preferably from one to four, preferably from one to two, preferably one. Preferably, the vinyl monomer comprises an ester or ether of: (i) an epoxy alcohol, or (ii) an acetylenic alcohol. Preferably, the vinyl monomer is an ether of an epoxy alcohol, preferably glycidyl alcohol (e.g., vinyl glycidyl ether). Preferably, the vinyl monomer is an ester of an epoxy alcohol. Preferably, the ester is a (meth)acrylate ester. Preferably, the epoxy alcohol is glycidyl alcohol. Preferably, the vinyl monomer is a (meth)acrylate ester of glycidyl alcohol, preferably glycidyl (meth)acrylate. In a preferred embodiment, the nanoweb is exposed in plasma to a vinyl monomer comprising at least one hydrophilic group prior to introduction of a vinyl monomer comprising at least one epoxy group. Preferably the hydrophilic group is a hydroxyl, carboxylic acid, polyethylene glycol, methoxy polyethylene glycol; preferably hydroxyl. Preferably, the vinyl monomer is a (meth)acrylate ester having a hydrophilic group on the ester alkyl group, a PEG (meth)acrylate, (meth)acrylamide or (meth)acrylic acid; preferably a hydroxyalkyl (meth)acrylate; preferably 2-hydroxyethyl methacrylate (HEMA), 2-hydroxyethyl acrylate (HEA), 2-hydroxypropyl methacrylate, 2-hydroxypropyl acrylate, 4-hydroxybutyl methacrylate, 4-hydroxybutyl acrylate, or a mixture thereof; preferably HEMA or HEA. In another preferred embodiment, the vinyl monomer comprising at least one hydrophilic group is contacted with the vinyl monomer and the nanoweb concurrently. The “functionalized nanoweb” is believed not to be completely coated with reacted vinyl monomer after exposure to plasma. The extent of the coating is important only in terms of the number of active sites which can react with a protein, as measured by the saturated binding capacity (SBC).

In a preferred embodiment of the invention, sheets of functionalized nanoweb having mean flow pore size from 0.1 to 5 μm and a porosity from 40 to 90 volume % and functional groups reactive with thiols are layered and cut as described herein, and then allowed to react with a protein. Preferably the functional groups reactive with thiols comprise at least one of: esters, alkynyl groups, conjugated alkenyl groups, quaternary ammonium salts, maleimides and epoxy groups; preferably esters or epoxy groups; preferably epoxy groups. The functionalized nanoweb can be produced using the plasma method described herein as well as conventional wet chemical reactions, typically using an epoxy-containing monomer or a (meth)acrylate ester monomer. Preferably, the functionalized nanoweb is not a carbohydrate polymer. Preferably, the functionalized nanoweb comprises PVDF, polyamide, polyethersulfone, polyethylene, polypropylene, polyester or polyimide. It is specifically contemplated that other features described herein and related to the properties of the functionalized or unfunctionalized nanoweb sheets, the methods of stacking and cutting, and the reaction with protein are suitable for use in combination with a functionalized nanoweb that comprises one or more of PVDF, polyamide, polyethersulfone, polyethylene, polypropylene, polyester or polyimide.

After die-cutting as described above, the functionalized nanoweb stacks are exposed to a protein in an aqueous medium. The protein comprises functional groups that are capable of forming a covalent bond. Preferably, the protein comprises a free cysteine thiol group, i.e., a thiol group (—SH) which is not part of a disulfide linkage, and also preferably said protein is active with respect to binding other proteins to an active site. Preferably, the protein comprising a free cysteine thiol group is obtained by cleaving a disulfide bond in the protein which is not required for maintaining the integrity of the protein binding site, i.e., the protein's activity for binding other proteins. Preferably, the disulfide is reduced using Tris(2-carboxyethylphosphine) hydrochloride (TCEP.HCl, also referred to herein as TCEP or Tcep) which can be used at a pH between 1.5 and 9.0 depending upon the stability of the protein being reduced at that pH. A typical pH for the reduction is pH 3 to pH 8, using non-phosphate buffers e.g. TRIS, HEPES, Borate. One advantage of TCEP is that it does not contain a thiol group and therefore does not require removal before reacting the free sulfhydryl of the protein with the epoxide groups on the nanofiber. Additional reducing agents include dithiothreitol (DTT), mercaptoethanol (ME), 2-mercapto-ethylamine hydrochloride (2- MEA.HCl) all of which are typically utilized around neutral pH. These three reagents all include free thiol groups and can be removed from the protein by filtration prior to reacting the protein with the nanofiber web to reduce competitive reactions during the conjugation of the protein. Cysteine-Cysteine disulfide bonds are frequently found in proteins as a method of maintaining the protein structure such that cleavage of these disulfide bonds can result in denaturation of the protein. Other structural features such as β-sheets, helix bundles and hairpin structures can maintain a protein's conformation without the use of disulfide linkages.

Preferably, proteins useful for affinity binding of other proteins or useful biotherapeutic molecules are produced recombinantly or isolated from natural sources. More preferably, the protein is one which has been produced recombinantly so as to include a disulfide linkage that is not involved in the configurational stability of the resulting protein; preferred proteins of this type include Protein A, Protein A/G and Protein G. Other preferred ligands include antibodies, which may be monoclonal and polyclonal; DNA; RNA; and the recognition fragments F(ab′) and F(ab′)₂, which can be produced recombinantly or following an enzymatic treatment to cleave the fragments from the intact antibody (Rosenstein et.al., Curr. Protoc. Mol. Biol. 2020 Jun.; 131(1):e119.doi: 10.1002/cpmb.119). Preferably, disulfide bonds which are reduced in the F(ab′)₂ are distal to the binding site of the protein and can be cleaved to form the individual fragments without loss of the ability to bind to other proteins, most likely because disulfide linkages that help to maintain the protein configuration occur within a β-secondary structure such as a β-sheet which maintains the protein configuration and protects these disulfides from reduction. Preferably, the protein is in an aqueous solution at a concentration from 5 to 50 mM. Preferably the pH of the solution is from 8 to 9.5, preferably from 8.5 to 9.3, preferably from 8.7 to 9.1, and also preferably the molecular weight of the protein is no greater than 150,000 Daltons, more preferably no greater than 100,000 Daltons and still more preferably no greater than 75,000 Daltons.

The nanoweb is contacted with a vinyl monomer to produce the functionalized nanoweb. Preferably, the vinyl monomer is contacted with the nanoweb in a plasma, preferably an atmospheric plasma. Preferably, a dielectric barrier discharge atmospheric pressure plasma process is used to attach the vinyl monomer to the nanofiber substrate. The dielectric barrier discharge plasma process preferably is a homogenous glow discharge process. Homogeneous glow discharge plasma processes are known in the art to produce spatially uniform low temperature electrons from injected gases at atmospheric pressures. Ions collide with the injected monomers producing ionized species that may self-polymerize in aerosol prior to substrate deposition. Preferred gases suitable for plasma generation include carbon dioxide, nitrogen, argon, and/or helium. The flow of gases in plasma form and in the injected monomer aerosol passes through a nozzle with a defined cross-sectional area. Preferably, for treating nonwoven roll goods, the nozzle is rectangular in geometry with an interelectrode gap. Also preferably, the width of the nozzle is larger than the width of the nonwoven. The inter-electrode gap is preferably 0.5-10 mm, preferably, 0.8-2 mm. The cross-sectional area of the nozzle used in the examples below is 5 cm² with a nozzle width of 40 cm. Preferably, gas flow rates range from 2 to 150 slm/cm², preferably from 60 to 100 slm/cm², where “slm” is an abbreviation for units of “standard liters per minute”, and wherein the gas volume is measured at or normalized to standard conditions, specifically, temperature of 0° C. and pressure of 1 atm (101 kPa). Gas flow rates through the plasma head will depend on plasma head size and substrate width to be coated with monomer as well as on environmental temperature and pressure of the gas. Injected monomer flow rates depend on the amount of monomer to be attached per area, of substrate. High injection rates of monomer may lead to self-polymerization prior to deposition on the substrate. Preferably, injection rates of aerosolized monomer range from 0.2 slm/cm² to 5 slim/cm². Dilutions of monomers may be achieved by one or more means of liquid solution mixing, by dissolution or suspension of a solid monomer in water or an appropriate solvent, and by introduction of greater gas flow into the liquid monomer pure compound, suspension, or solvent mixture. Preferred dilution ratios (solvent or carrier to monomer) range from of 2:1 to 50:1, preferably from 3:1 to Preferably, alternating current powered covered electrodes generate the plasma through a narrow gap at atmospheric pressures from 0.9-1.1 atm (91-111 kPa). Preferably, plasma source voltage ranges from 1-100 kV with preferred range of 5 to kV. Preferably supplied power for initial activation and reaction with monomer is in the range of 2 to 300 W/cm², preferably 20 to 200 W/cm², preferably 30 to 160 W/cm². Preferably supplied power in the presence of protein is in the range of 1 to 100 W/cm², preferably 2 to 40 W/cm², preferably 3 to 20 W/cm². Preferably, the distance between the substrate and the plasma head is 1-10 mm, preferably 2-5 mm. Preferably, the substrate is pretreated using carbon dioxide, nitrogen, argon, and/or helium in an atmospheric plasma process without monomer.

The following examples are provided to describe the invention in further detail. These examples, which set forth a preferred mode presently contemplated for carrying out the invention, are intended to illustrate and not to limit the invention.

### Examples

Methods

Characterization of Stacked Membranes:

Die-cut stacked membranes were characterized by two different techniques. The first method of characterization is IgG binding capacity and the second is FT-IR analysis of dried Protein A functionalized membranes. The main objectives of the characterization are to demonstrate that Protein A can be successfully coupled with epoxy groups of membrane in stacked format and to show that coupling of Protein A is fairly uniform in all the layers of stacked membranes. We have demonstrated this substantial uniformity with 5, 10 or 12 layers of epoxy functional membranes.

IgG Binding Capacity

In general, a known quantity of the target protein solution is passed through a known volume of membrane held in a membrane holder. As the target protein solution flows through the membrane, the elution of protein solution is measured by UV. The amount of the target protein bound to the membrane is calculated from the difference in UV signal between the mass of protein charged and mass bound in the membrane. The value reported is the amount of protein bound per volume of the membrane. See, for example,

https://www.cytivalifesciences.comienlus/solutions/bioprocessinalnowledge-center/fiber-based-chromatography-dynamic-binding-capacity

FT-IR Analysis

Protein A functionalized membranes and die-cut stacks are wet when synthesized. For FT-IR analysis, the individual membranes (as functionalized or removed from a functionalized die-cut stack) were dried in air prior to FT-IR analysis. FT-IR spectra were recorded in a transmission mode. Peaks due to the presence of >CONH group of protein A appear in the spectra of functionalized membranes. The intensity of the amide peak was calculated by subtracting the background spectrum of the base PVDF membrane.

FT-IR spectroscopy analysis was used for—(i) detecting the presence of Protein A on membrane after coupling reaction is complete. (ii) Relative intensity of anode peak was used for comparing the amount of Pro A between membrane samples. (iii) FT-IR spectroscopy was used for determining the uniformity of coupling reaction in larger size coupons at different locations and (iv) for determining the uniformity of the coupling reaction within each layer of membrane in the die-cut functionalized nanoweb stacks (10 cm×10 cm wide, 5 or 10 or 12 layers).
Functionalization to attach Protein A was done on a stack of 5 membranes, rather than a single layer. FTIR analysis was used to determine if the functionalization was homogeneous across the stack.
FTIR spectroscopy was used to measure the amount of Protein A on the membranes. Protein A was observed by the amide C═O stretch at 1658 cm⁻¹ and the amide NH bend at 1545 cm⁻¹.
FTIR spectra were measured by transmission in a Thermo 6700 instrument. Samples were held in a magnetic film bolder, with no supporting substrate.
Peak heights were calculated by the following definitions. The amide C═O peaks between samples were normalized to an FTIR signal on an uncoated PVDF membrane.

### Example 1: Stacking of 5 Layers

A sheet of Tyvek® flash-spun film, referred to herein informally as a “paper”, approximately 24 cm wide and 2 ft long was laid on a countertop and fixed using adhesive tape. Care was taken to make sure that the Tyvek® paper was lying flat, and no wrinkles or fold overs were present. Five layers of epoxy-functionalized nanoweb (10.25 inch (26.04 cm) wide and 1.7 ft (51.82 cm) long) made by exposing PVDF (0.5 micron) to glycidyl methacrylate in a plasma were unrolled sequentially over the Tyvek®) paper. The characterization data of the functionalized nanoweb are set forth in the following table:

| | | | | | MFP | |
|---|---|---|---|---|---|---|
| | Thick- | | Gurley | | (mean | |
| | ness | | air | | Flow | |
| Basis | (micro- | | flow | MinPore | Pore) | MaxPore |
| Weight) | meter) | Porosity | (sec) | (microns) | (micron) | (microns) |
| 10.2 | 15.3 | 0.616 | 4.7 | 0.279 | 0.38 | 0.64 |

The layers were primarily held together by electrostatic interaction. The stack was fixed to the Tyvek® paper by applying adhesive tape at the corners and on sides. Adhesive tape covered approximately 2-3 mm of the functionalized nanoweb. The stack was covered with a polyethylene sheet. The stack was then slid into a polyethylene film bag to prevent the damage to membrane surface during the cutting process. Use of a transparent polyethylene bag also makes it easy to observe the membrane stack visually during cutting process. Next, die-cut functionalized nanoweb stacks of various sizes were punched from the stacked membranes using a suitable cutting die. The dies used for cutting had a round, square or rectangular shape. The cutting die was placed on the top of the stacked sheet. The stack of membranes, still inside the polyethylene bag, was then placed in manual press.

Pressure was applied to the bagged nanoweb stack via the cutting die. The stack was rotated in 2 or 3 turns through all sides (total rotation of 360° C.) inside the die, and pressure was applied after each rotation. The Maximum Pressure of the manual press was 5 tons. Pressure was applied manually for 1 or 2 seconds, 2 or 3 times, in order to ensure a smooth and uniform cut along the entire perimeter of the die-cut functionalized nanoweb stack.

### Example 2

Stacking for 10 layers and 12 layers:

The above procedure was repeated by laying down ten layers or twelve layers on membrane on top of the Tyvek® flash-spun film instead of five layers. Stacks having 10 or 12 layers were then slid into a polyethylene film bag to prevent the damage to membrane surface during the cutting process. The functionalized nanoweb stacks were placed in transparent polyethylene bags and die-cut as described in Example 1, above.

After stacked membrane was die-cut, it was separated from the residual Tyvek® paper and polyethylene layers and inspected manually to make sure that all the functionalized nanoweb layers were bonded together at the edges along the entire perimeter of the die-cut stack. Die-cut functionalized nanoweb stacks of desired shape were rewetted with 25% ethanol. Each rewetted functionalized layer was capable of separation from the die-cut stack by applying gentle pressure just below the outer edges and manually pulling the layer out from the stack. The stacked, die-cut, functionalized membranes were easy to handle. They remained firm during entire synthesis and fabrication, and during storage.

### Example 3

Ligation (or Immobilization) of Stacked Membrane

Protein A ligation (or immobilization) was carried out on die-cut functionalized nanoweb layers having a diameter of 47 mm (“discs”). Each stack included 5 layers of functionalized nanoweb. 10 stacks (total 50 discs) were used for the immobilization of Protein A (Pro A). Protein A immobilization was carried out using formulation outlined in the following table.

| | ml of | | DI | | | Pro A | | conc |
|---|---|---|---|---|---|---|---|---|
| | ProA | total mg | water | Diluted | | sulfate | total | of |
| # | re- | ProA in | added | volume | Tcep | pH | volume | ProA |
| discs | quired | solution | (ml) | (ml) | (ml) | 9.72 | (ml) | mg/ml |
| 50 | 18.9 | 378 | 29.9 | 48.8 | 0.80 | 64.9 | 114.50 | 3.30 |

Pro A solution (18.9 ml) was added to a 200 ml plastic jar. 29.9 ml of deionized water (DI water) was added to the Pro A solution. After mixing gently, 0.8 ml of TCEP solution was added to the diluted Pro A solution and the mixture was shaken for 30 minutes to reduce the disulfide bonds of Pro A. While Pro A activation was in progress, in a separate glass tray, supporting Tyvek® spun-bonded film (“paper”) above or below the membrane stack was removed from each stack. The stacks were prewetted with 25% ethanol. The wetted membrane stacks were transferred to a glass plate and excess of ethanol solution was absorbed using clean absorbent paper.
Ammonium sulfate solution (3.5M, 64.9 ml, pH>9.6) was slowly added to the activated Protein A solution and shaken until mixing was complete. The 10 stacks of prewetted membrane samples were then slowly added to the reaction container containing Protein A and ammonium sulfate solution while gently shaking the container.
The reaction container was closed and transferred to incubator, where it was shaken for 16 to 18 hours at a temperature between 25 and 26.8° C. while the Protein A immobilization reaction progressed.
After the incubation was completed, the reaction solution was drained entirely from the container. Deionized (DI) water (229 ml) was added to the membranes in a container, which was transferred to incubator and was shaken for 5 minutes at a temperature between 25 and 26.8° C. The DI water was drained entirely from the membranes. The membranes were incubated twice more with the same quantity of DI water under the same conditions, except that they were shaken for 10 minutes before draining completely.

End Capping with Ethanolamine:

Epoxy groups that are not reacted with ProA were capped by reacting them with ethanolamine, according to well-known commercial methods for epoxy activation of resins and membranes.

Here, membrane stacks were immersed in 114.5 ml of 0.79 M of ethanol amine solution. The reaction container was tightly closed and transferred to an incubator at for 2 hrs with gentle shaking at a temperature between 25 and 26.8° C. After 2 hrs, the ethanol amine solution drained from the container and membrane stacks were washed with 229 ml of DI water twice. After DI water washing was complete, the membrane stacks were washed with 25% ethanol twice. Finally, wet membrane stacks were stored in 25% ethanol.

Control Experiment:

Instead of the die-cut functionalized stacked membrane, 50 individual discs of the vinyl-functionalized nanoweb of Example 1 were coupled with Pro A using the procedure of Example 3.

IgG Binding capacity:

IgG binding capacity data are summarized in the following Table.

| | | | g IgG/L |
|---|---|---|---|
| | | | Membrane |
| Sample ID | Sample | Details | (DBC10) |
| 133-A | 50 single layers ligated | Tested 10 individual | 27.5 |
| | | layers | |
| 133-C | Ligated die-cut stacks | 10 stacks tested | 28.8 |
| | of 50 layers | | |

Results:

### Example 3: The >CONH Peak for Each Layer of Stack Containing 5 Layers is Shown in the Table Below

PVDF peak table (cm₋₁)

| | |
|---|---|
| 3017 | 1185 |
| 2978 | 1072 |
| 1756 (obscured) | 947 |
| 1721 (obscured) | 884 |
| 1595 (obscured) | 842 |
| 1453 | 763 |
| 1431 | 747 |
| 1402 | 601 |
| 1334 | 510 |
| 1278 | 470 |

Protein A peak table (cm⁻¹)

| | |
|---|---|
| 3301 | NH str |
| 1732 | Ester C═O |
| 1658 | Amide C═O |
| 1543 | Amide NH bend |
| 3301 | NH str |
| 1732 | Ester C═O |
| 1658 | Amide C═O |
| 1543 | Amide NH bend |

FT-IR Peaks of 5-layer stack

Peak at 1732 cm⁻¹ is due to the presence of ester groups from glycidyl methacrylate and peaks at 1659 and 1544 cm⁻¹ are due to the >CONH groups of Pro A.

Each layer of ligated stacked membrane was separated. Intensity of >CONH peak at 1658 cm⁻¹ was plotted for each layer separated from stacked disc.

Peak intensity on individual Discs isolated from 5 Layer Stack:

| Sample | Amide C═O, 1658 cm⁻¹ | Ester C═O, 1730 cm⁻¹ |
|---|---|---|
| piece #1 | 0.917343 | 0.128317 |
| piece #2 | 0.900793 | 0.109037 |
| piece #3 | 0.912991 | 0.115463 |
| piece #4 | 0.907876 | 0.111139 |
| piece #5 | 0.925933 | 0.131498 |

An FTIR analysis of the amide C═O and ester C═O peak from each layer in the stack show that the each layer of the membrane was activated while in the stack format. Thus indicating that the protein A is able to readily diffuse through the stack during the activation step. The FTIR signal and the IgG dynamic binding capacity of the membrane follow a similar trend, so the FTIR signal can be used as an approximation of the likely binding capacity of the membrane.

### Example 4

Square vinyl-functionalized nanoweb stacks of 5 layers were cut using a 55×55 mm die in the hand press. Coupons were cut by applying manual pressure on each side by rotating membrane sheet.

Protein A immobilization was carried out using the procedure of Example 3 and the following formulation. The die-cut functionalized nanoweb stacks remained integral after ligation and reaction work up.

| | | ml of | DI | | | | conc | |
|---|---|---|---|---|---|---|---|---|
| | | ProA | water | | Pro A | total | of | Total |
| | # | re- | added | Tcep | sulfate | volume | ProA/ | Pro |
| | coupons | quired | (ml) | (ml) | 3.5 M | (ml) | ml | A |
| 55 mm × | 20 | 13.10 | 20.72 | 0.56 | 44.98 | 79.37 | 3.30 | 262 |
| 4 stacks | | | | | | | | mg |

The results of the IgG binding are shown in the table below.

| Sample | Details | g IgG/L Membrane (DBC10) |
|---|---|---|
| 55 mm Square | Stacked coupons | 27.4 |

### Example 5

A rectangular vinyl-functionalized nanoweb stack of 5 layers cut using a die of dimension 6.73×16.5 cm manually as outlined in the above examples. Protein A immobilization was carried out using the procedure of Example 3 and the following formulation. The die-cut functionalized nanoweb stacks remained integral after ligation and reaction work up.

| | | | | | DI | | Pro A | |
|---|---|---|---|---|---|---|---|---|
| | | | Pro A | | water | | sulfate | total |
| | | # | (mg) | ml of | added | Tcep | 3.5 M | volume |
| length | width | coupons | needed | Pro A | (ml) | (ml) | (ml) | (ml) |
| 16.5 | 6.73 | 15 (5 × 3 | 363.09 | 18.15 | 26.42 | 0.77 | 64.74 | 110.09 |
| | | stacks) | | | | | | |

The results of the IgG binding are shown in the table below.

| Sample | g IgG/L Membrane (DBC10) |
|---|---|
| Sq-1 | 19.8 |
| Sq-2 | 19.8 |
| Sq-3 | 19.7 |

### Example 6

Ligation in 12 layers of Membrane:

Discs having a diameter of 47 mm and containing 12 layers of membrane were ligated to show that Protein A coupling is uniform across the stacked layers.

The discs were cut using a manual press. Protein A solutions of different concentrations were used to perform the immobilizations. In the first step, after Ammonium sulfate solution was added to the activated Protein A solution, the remainder of the procedure was carried out as outlined in Example 3.

| ml of Pro A | DI water | | Pro A sulfate | total volume (ml) |
|---|---|---|---|---|
| added | added(ml) | Tcep (ml) | 3.5M | (stock solution) |
| 3.78 | 4.98 | 0.16 | 13.98 | 22.90 |

Characterization of 12-Layer Stacked Membrane.

FT-IR analysis of stacks of membrane consisting of 12 layers were analyzed by FT-IR. Peak intensity due to >CONH group at 1658 cm⁻¹ was measured for of each layer. The peak intensity of the 12-layer stacks shows that Protein A is uniformly bound to the surface of the membrane.

| Sample (12 layers) | Amide C═O, 1658 cm⁻¹ | Ester C═O, 1730 cm⁻¹ |
|---|---|---|
| B 1 | 0.823497 | 0.171788 |
| B 2 | 0.797318 | 0.165621 |
| B 3 | 0.780301 | 0.156642 |
| B 4 | 0.753635 | 0.162539 |
| B 5 | 0.763696 | 0.175297 |
| B 6, | 0.720092 | 0.1556450 |
| B 7 | 0.763832 | 0.166851 |
| B 8 | 0.823079 | 0.167851 |
| B 9 | 0.819765 | 0.16003 |
| B 10 | 0.808458 | 0.16974 |
| B 11&12 | 0.808711 | 0.165606 |

Advantageously, the die-cut functionalized stacked membranes are easy to handle. They remain adhered as stacks during synthesis and storage. However, when membranes are cut from individual membrane layers and functionalized, the discs become folded or curled making them difficult to separate and handle.

In summary, it has been demonstrated that Pro A can be uniformly coupled in each layer of a die-cut multilayer stack of membranes. This technique offers several benefits over conventional methods of coupling protein/biomolecules in one membrane layer at a time, prior to layering the membranes and cutting the multilayer membrane stacks.

Further, die-cut stacked functionalized membranes of desired shape and size can be dried and can be assembled into a device directly. Thus, the die-cut stacked membranes can be assembled into the device without any waste or scrap.

While certain of the preferred embodiments of this invention have been described and specifically exemplified above, it is not intended that the invention be limited to such embodiments. Various modifications may be made without departing from the scope and spirit of the invention, as set forth in the following claims.

1. A method for producing a chromatography medium: said method comprising steps of:
a) exposing a nanoweb having mean flow pore size from 0.1 to 5 μm and a porosity from 40 to 90 volume % to a gaseous phase comprising a vinyl monomer to produce a functionalized nanoweb;
b) layering a plurality of sheets of the functionalized nanoweb to form a functionalized nanoweb stack;
c) cutting said functionalized nanoweb stack with a die to form a die-cut functionalized nanoweb stack; and
d) exposing said die-cut functionalized nanoweb stack in an aqueous medium to a ligand which is capable of forming a covalent bond.

2. The method of claim 1 wherein the ligand is capable of affinity binding.

3. The method of claim 1 wherein the ligand is a protein comprising a free thiol or amino group.

4. The method of claim 1 wherein the ligand is selected from the group consisting of Proteins A, G, A/G; monoclonal antibodies; polyclonal antibodies; the recognition fragments F(ab′) and F(ab′)₂; DNA; and RNA.

5. The method of claim 1 wherein the vinyl monomer comprises at least one epoxy group.

6. The method of claim 1 wherein the nanoweb is not a carbohydrate polymer.

7. The method of claim 1 wherein the vinyl monomer comprises an ester or ether of: (i) an epoxy alcohol, or (ii) an acetylenic alcohol.

8. The method of claim 1 wherein the nanoweb comprises PVDF, polyimide, polyethersulfone, polyethylene, polypropylene, polyester or polyimide.

9. The method of claim 1 wherein the functionalized nanoweb stack is cut by applying pressure only with an unheated die.

10. The method of claim 1 wherein the functionalized nanoweb stack comprises from 3 to 15 functionalized nanoweb sheets.

11. The method of claim 1 wherein the functionalized nanoweb sheets in the die-cut functionalized nanoweb stack are adhered only at their edges.

12. A method for producing a chromatography medium from a functionalized nanoweb having mean flow pore size from 0.1 to 5 μm, a porosity from 40 to volume %, and functional groups reactive with thiol or amino groups; said method comprising steps of: a) layering a plurality of sheets of functionalized nanoweb to form a functionalized nanoweb stack; b) cutting said functionalized nanoweb stack with a die to form a die-cut functionalized nanoweb stack; and c) exposing said die-cut functionalized nanoweb stacks in an aqueous medium to a ligand which: (i) is capable of binding a biomolecule to an active site, and (ii) comprises a free thiol or amino group.

13. The method of claim 12 wherein the ligand is selected from the group consisting of Proteins A, G, AG; monoclonal antibodies; polyclonal antibodies; the recognition fragments F(ab′) and F(ab′)₂; DNA; and RNA.

14. The method of claim 12 wherein the functionalized nanoweb comprises functional groups that are reactive with thiols.

15. The method of claim 14 wherein the functional groups comprise epoxy groups or ester groups.

16. The method of claim 12 wherein the functionalized nanoweb does not comprise a carbohydrate polymer.

17. The method of claim 12 wherein the functionalized nanoweb comprises PVDF, polyamide, polyethersulfone, polyethylene, polypropylene, polyester or polyimide.

18. The method of claim 12 wherein the functionalized nanoweb stack and the die are at ambient temperature and the functionalized nanoweb stack is not under pressure at any point except along the cutting surface of the die.

19. The method of claim 12 wherein the functionalized nanoweb sheets in the die-cut functionalized nanoweb stack are adhered only at their edges.

20. The method of claim 12 wherein the functionalized nanoweb stack comprises from 3 to 15 functionalized nanoweb sheets.
